(19) United States
(12) Patent Application Publication
(10) Pub. No.: US 2013/0065745 A1
(43) Pub. Date: Mar. 14, 2013

(54) METHOD FOR PROVIDING GLASS INFORMATION AND GLASS MATERIAL

(71) Applicants: Shigeru AOYAGI, Shinjuku-ku (JP); Jun Nakamura, Shinjuku-ku (JP); Kazuo Tachiwana, Shinjuku-ku (JP); Junko Akojima, Shinjuku-ku (JP)

(72) Inventors: Shigeru AOYAGI, Shinjuku-ku (JP); Jun Nakamura, Shinjuku-ku (JP); Kazuo Tachiwana, Shinjuku-ku (JP); Junko Akojima, Shinjuku-ku (JP)

(73) Assignee: HOYA CORPORATION, Tokyo (JP)

(21) Appl. No.: 13/605,143

(22) Filed: Sep. 6, 2012

(30) Foreign Application Priority Data
Sep. 7, 2011 (JP) 2011-194833

(51) Int. Cl. G06F 17/30; C03C 3/00

(52) U.S. Cl. 501/11; 707/758; 707/E17.014

(57) ABSTRACT

There is provided a method for providing glass information and a glass material capable of preventing a generation of a gap between an evaluation regarding chemical durability of the glass material and an actual surface state, which is the method for providing glass information for providing information regarding the chemical durability of the glass material, wherein a correlation between a variation of hydrogen ion concentration indexes of a process liquid in which the glass material is immersed, and a variation of chemical durability index values of a prescribed types of glass materials, is tabulated in a visible form, and is provided individually for each type of the glass materials.

### BACKGROUND

1. Technical Field

The present invention relates to a method for providing glass information for providing information regarding chemical durability of a glass material, and a glass material whose information is provided by the method for providing glass information.

2. Description of Related Art

A surface degradation (such as white fogging, blue fogging, and latent flaw) that can be generated in a glass material for forming an optical element such as a lens and a prism, is closely related to a chemical durability of the glass material. The chemical durability of the glass material means the durability when chemical reaction occurs between a glass material component and process liquid (cleaning liquid and polishing liquid, etc.), and more specifically water resistance, acid resistance, and detergent resistance, etc., can be given as the durability. Such a chemical durability is different depending on a chemical composition of the glass material, and therefore is indispensable for evaluating the glass material.

Conventionally, the chemical durability of the glass material is tested and evaluated by a technique defined by Japan Optical Glass Industry Association Standard, and a result thereof is provided form a glass material manufacturer. More specifically, for example a water resistance class powder method (Dw), acid resistance class powder method (D_{A}), chemical durability (D_{O}), latent flaw resistance (D_{STTP}), latent flow resistance (D_{NaOH}), and blue fogging resistance surface method (T_{blue}), are tested and evaluated, so that each type of these indexes is classified into grades 1 to 6 (for example, see non-patent documents 1 and 2).
Non-patent document 1: “Method for measuring chemical durability of optical glass (surface method)” by Japan Optical Glass Industry Association Standard JOGIS07-1975
Non-patent document 2: “Technical information (chemical property)”, [online], HOYA GROUP optics division, [searched in Sep. 7, 2011], Internet <URL:http://www.hoya-opticalworld.com/japanese/techn ical/003.html>

However, the above-described conventional technique sometimes involves a problem as described below, regarding the test and evaluation of the glass material.

For example, according to conventional evaluation result information, when six types (D_{W}, D_{A}, T_{blue}, D_{NaOH}, D_{STTP}, D_{O}) of the glass material are tested and evaluated, it is found that the chemical durability of all glass materials of glass type called “FDS18(by HOYA Corporation)” is classified into grade 1, and these glass materials have excellent chemical durability. However, when a lens being an optical element is fabricated through a grinding step, a polishing step, and a cleaning step using cleaning liquid applied to the FDS18, there is a problem that a latent flaw is generated on a surface of the lens in a process of coating the surface of the lens with an antireflection film. Namely, although conventional evaluation result information shows that the chemical durability is entirely grade 1, an actual lens surface is degraded with elapse of time in some cases. This means that there is sometimes a gap between the conventional evaluation result information and an actual degradation state of the surface of the lens.

Therefore, an object of the present invention is to provide a method for providing glass material information and a glass material, capable of preventing a generation of a gap between an evaluation result and an actual surface state of the lens.

### SUMMARY OF THE INVENTION

In order to achieve the above-described objects, inventors of the present invention study on a reason for degrading an actual state of the surface of the lens with elapse of time, irrespective of using the glass materials all of which having grade 1 chemical durability in conventional evaluation result information.

As a result of such a study, it is assumed by the inventors of the present invention as follows, as the reason for degrading the actual surface state of the lens with elapse of time.

(Reason 1) Performance supposed to be possessed by the glass material is not completely evaluated by the conventional technique. Namely, the glass material has a characteristic that does not appear by conventional evaluation result information.
(Reason 2) Processing which is not performed in testing and evaluating the glass material, has an influence on the actual surface of the lens as an external factor.

First, the reason 1 is as follows. Each type of chemical durability including acid resistance, etc., is evaluated by the conventional technique, and the conventional technique is pursuant to the content defined in the Japan Optical Glass Industry Association Standard. Therefore, hydrogen ion concentration index (called “pH” hereafter) in a process liquid of each type of index to be evaluated in which a glass material sample is immersed, is fixedly defined. Further, evaluation conditions are not equalized in each type of indexes, regarding not only pH of the process liquid, but also a shape and a size of the glass material, immersion time required for immersion into the process liquid, and a liquid temperature, etc.

Further, the conventional technique employs discrete evaluation stages such as grade 1 to grade 6, and does not employ a more detailed technique of classifying and evaluating the glass material having more excellent durability than grade 1.

From these facts, the inventors of the present invention considers as follows: the point is that an influence of pH variation of the process liquid in which the glass material is immersed, cannot be grasped by the conventional evaluation result information, and it appears that this point shows that the present invention has a characteristic that is not grasped by the conventional evaluation result information.

Next, the reason 2 is as follows. A producing step of fabricating a lens generally includes a cleaning step using a cleaning liquid. Then, in the cleaning step, a cleaning power is improved by using strongly alkaline cleaning liquid. Probably the inventors of the present invention assume that pH of the cleaning liquid used in the cleaning step has an influence on the state of the lens surface as the external factor, thus degrading the state of the lens surface with elapse of time.

As a result of strenuous efforts by the inventors of the present invention based on the above-described reasons 1 and 2, irrespective of a common sense that the contents defined by the Japan Optical Glass Industry Association Standard should be complied with, a completely new unconventional concept is found as follows. Namely, pH of the process liquid is varied and the influence thereof is tested and evaluated. Thus, based on such a concept from a different angle, the inventors of the present invention obtains a knowledge that the above-described problems can be solved by performing test and evaluation so that the influence of pH on the chemical durability of the glass material (namely the characteristic that is not grasped by the test and the evaluation based on the conventional technique) can be grasped, separately from the contents defined by the Japan Optical Glass Industry Association Standard.

Then, the aforementioned knowledge is put into practice, and a correlation between pH and the chemical durability is grasped and by utilizing such a correlation, the inventors of the present invention obtain a knowledge that the generation of the gap between the evaluation applied to the glass material and the actual surface state of the glass material can be prevented even after the glass material is actually turned into a product such as an optical element, which is the glass material whose chemical durability is evaluated to be a high grade by the conventional technique.

In addition, even in a case of the glass material whose chemical durability is evaluated to be a low grade by the conventional technique, by setting pH of the process liquid used for producing the optical element in a range of the pH determined for each type of the glass material, the chemical durability of the glass material can be sufficiently extracted in some cases, so as not to be inferior to the optical element based on the glass material whose chemical durability is evaluated to be a high grade.

Based on such a new knowledge by the inventors of the present invention, the present invention is provided, and a first aspect of the present invention provides a method for providing glass information for providing information regarding chemical durability of a glass material, comprising:

tabulating a correlation between a variation of hydrogen ion concentration indexes of a process liquid in which the glass material is immersed, and a variation of chemical durability index values of a prescribed type of the glass material immersed in the process liquid, in a visible form; and

providing the glass information individually for each type of the glass materials.

A second aspect of the present invention provides the method of the first aspect, wherein haze values of the glass materials after being immersed in the process liquid for a prescribed time, are used as the chemical durability index values.

A third aspect of the present invention provides the method of the second aspect, wherein weight variation values of the glass materials before/after being immersed in the process liquid for a prescribed time, are used as the chemical durability index values.

A fourth aspect of the present invention provides the method of the third aspect, wherein tabulation is made in a graph in which the hydrogen ion concentration indexes are taken on the horizontal axis, and the haze values are taken on one of the vertical axes, and the weight variation values are taken on the other vertical axis.

A fifth aspect of the present invention provides the method for providing glass information according to any one of the first to fourth aspects, wherein information tabulated individually for each glass type is provided in a list on a glass map, regarding a plurality of glass types that exist on the glass map classified by refractive index nd and Abbe number νd.

A sixth aspect of the present invention provides a glass material, which is the glass material being a material for forming an optical glass, wherein a correlation between a variation of hydrogen ion concentration indexes of a process liquid in which the glass material is immersed, and a variation of chemical durability index values of a prescribed type of the glass materials immersed in the process liquid, is attached individually for each type of the glass materials in a tabulated state and in a visible form, as information regarding the chemical durability of the glass materials.

According to the present invention, the influence of the variation of the hydrogen ion concentration indexes on the chemical durability index values, can be grasped. Therefore, the generation of the gap between the evaluation for the glass material, and the actual surface state of the glass material can be prevented. As a result, the chemical durability possessed by the optical element can be sufficiently exhibited.

### BRIEF DESCRIPTION OF THE DRAWINGS

FIG. 1 is a view in which Abbe number and a refractive index possessed by each type of glass materials are plotted by center points of hexagons indicating each type of the glass materials, in which the Abbe number νd is taken on the horizontal axis, and the refractive index nd is taken on the vertical axis. Note that a chemical durability index based on the Japan Optical Glass Industry Association Standard JOGIS07 is indicated by a region at each side of each hexagon showing each type of the glass materials. Also, note that the type of the chemical durability index is different depending on the region at each side as follows: an upper side region of the hexagon indicates a water resistance class powder method (Dw), and a region adjacent to the upper side region of the hexagon clockwise therefrom (namely upper right region) indicates an acid resistance class powder method (D_{A}), and a lower right region indicates a blue fogging resistance surface method (T_{blue}), and a lower side region of the hexagon indicates a latent flow resistance (D_{NaOH}), and a lower left region indicates a latent flaw resistance (D_{STTP}), and an upper left region indicates a chemical durability (D_{O}). Further, a difference in grades of the chemical durability is shown by a pattern in each region.

FIG. 2A is a view showing a result of a test performed to a glass material for example 1 (glass type: FDS18), in which pH is taken on the horizontal axis, haze values (%) are taken on a right vertical axis, and weight variation values (g) are taken on a left vertical axis, which are plotted in this figure. FIG. 2B is a view showing a result of a test performed to a glass material for example 16 (glass type: M-FCD1), in which pH is taken on the horizontal axis, haze values (%) are taken on the right vertical axis, and weight variation values (g) are taken on the left vertical axis, which are plotted in this figure.

### DESCRIPTION OF DETAILED EMBODIMENT OF THE INVENTION

Detailed embodiments of the present invention will be described hereafter.

This embodiment will be described in detail in the following order.

### 1. Outline

2. Acquisition of information
3. Providing of information
4. Utilization of information
5. Effect of this embodiment

### 6. Others

### 1. Outline

As described above, inventors of the present invention consider that conventional evaluation result information involves a problem that an influence of pH of the process liquid in which the glass material is immersed, cannot be grasped, and consider that the problem can be solved by performing a test of grasping the influence of pH separately from a content defined in Japan Optical Glass Industry Association Standard, based on an unconventional completely new concept, and providing a result thereof as glass information.

The method for providing glass information described in this embodiment, which is achieved based on a new knowledge by the inventors of the present invention, provides information capable of grasping the influence of the hydrogen ion concentration index (pH) of the process liquid in which the glass material is immersed, as the information regarding the chemical durability of the glass material.

Here, the glass material includes a material for forming an optical element or an optical glass, with chemical composition different depending on the type of the glass material (simply called “glass type” hereafter). Accordingly, the chemical durability of the glass material is different if the glass type is different.

The chemical durability of the glass material means the durability when a chemical reaction occurs between a glass component and a process liquid (cleaning liquid, polishing liquid, etc.), and a chemical durability index value is used as an objective reference (index) for evaluating the durability.

Various kinds of index values can be used as the chemical durability index value, and “haze value” and “weight variation value” are used as will be described later in detail, as prescribed kinds of chemical durability index values in this embodiment.

According to this embodiment, information identifying the correlation between the variation of pH of the process liquid and the variation of the chemical durability index values of the glass material immersed in the process liquid, is used as the information capable of grasping the influence of pH of the process liquid in which the glass material is immersed. This is because the influence of pH of the process liquid can be grasped by identifying each correlation (what kind of variation occurs when one of the aforementioned values is varied). Namely, the influence of pH of the process liquid cannot be grasped only by complying with the content defined in Japan Optical Glass Industry Association Standard like a conventional technique, because pH of the process liquid is fixedly defined. Meanwhile, according to this embodiment, in order to solve the problem caused by not grasping the influence of pH, the influence of pH of the process liquid is grasped using information identifying the correlation between the variation of pH and the variation of the chemical durability index values, based on an unconventional completely new concept.

Regarding the correlation between the variation of pH and the variation of the chemical durability index values, it can be considered that a test is performed by a test method specifically described in “2. Acquisition of information” as will be described later, to thereby acquire the information for each type of the glass materials.

Further, regarding the acquired glass information (information regarding the correlation), the information is provided to a user of the glass material (fabricator, etc., of the glass material) by a providing method specifically described in “3. Providing of information” as will be described later. Namely, as will be described later in detail, the correlation between the variation of pH and the variation of the chemical durability index values is tabulated in a visible form, so as to be provided individually for each type of the glass materials. Thus, according to this embodiment, the information regarding the chemical durability is not provided by a discrete evaluation such as grades 1 to 6 like the conventional technique, but is provided in a visible form for the user of the glass material, based on an unconventional completely new concept.

As described above, in this embodiment, the information regarding unconventional content of the correlation between the variation of pH and the variation of the chemical durability index values, is provided by an unconventional technique of tabulating the information in the visible form individually for each type of the glass materials, as the information regarding the chemical durability of the glass materials. Namely, in this embodiment, there is a technical characteristic in providing the information (namely, in a content itself of the information to be provided, and in a technique of providing the information), clearly indicating a contribution to the conventional technique of complying with the content defined by Japan Optical Glass Industry Association Standard. Accordingly, the method for providing glass information described in this embodiment, corresponds not to providing of the information simply, but to creation of a technical concept utilizing a natural law.

It can be considered that the information thus provided, is utilized as specifically described in “4. Utilization of information” as will be described later. Namely, as will be described later in detail, it can be considered that for example the user of the glass material selects pH of the process liquid used for performing processing to each type of the glass materials, with reference to the provided information, and perform processing (polishing and cleaning, etc.) to the glass material using the process liquid having the selected pH, to thereby produce the optical element.

### 2. Acquisition of Information

Acquisition of information in this embodiment is performed as described below.

When the acquisition of information is performed, first, a glass sample is prepared for each type of the glass materials whose information is supposed be acquired. The glass material is processed into a disc shape in a diameter of 43.7 mm and a thickness of 5 mm, and a sand-falling test is performed to two main opposed surfaces (planes with a diameter of 43.7 mm) with granularity of #1200 defined in JIS R 6001 (granularity of a polishing material), using A-abrasive grain defined in JIS R 6111 (artificial abrasive). Then, the glass material thus processed is polished using a straight asphalt pitch and cerium oxide (CeO₂) to be finished so that a grey is not observed through a loupe, to thereby obtain the glass sample. However, the glass sample is not limited thereto, and other one may be acceptable, provided that it can be immersed in the process liquid.

Further, in addition to the glass sample, the process liquid is prepared in a container having a size capable of containing the glass sample therein, for immersing the glass material therein. Liquid (such as polishing liquid and cleaning liquid) used in a process of producing the optical element from the glass material is assumed to be used as the process liquid. Namely, the liquid used until completion of the optical element as a product is used as the process liquid. Then, the glass sample is immersed in this process liquid, and a variation manner of the chemical durability index values according to the pH variation, is tested.

Wherein, regarding the process liquid prepared here, hydrogen ion concentration index (pH) thereof is set so as to be suitably adjusted. It can be considered that pH adjustment is performed in such a way that pure water is used as neutral process liquid, and nitric acid (HNO₃) is added when the pure water is turned into acidic, and sodium hydroxide (NaOH) is added when the pure water is turned into alkaline. Namely, HNO₃ and NaOH are used for the pure water, and a mixing ratio of the HNO₃ and NaOH is varied. This can be given as a specific example of the process liquid. Note that the process liquid is not limited thereto, and other process liquid may also be used provided that the pH adjustment can be performed.

After the glass sample and the process liquid are prepared, the glass sample is immersed in the process liquid which is adjusted to a certain pH and maintained to have a prescribed temperature (for example 50° C.) for a prescribed time (for example 15 hours). Note that the temperature and the time, etc., may be suitably set and are not limited to specific values.

Thereafter, regarding the glass sample extracted from the process liquid, prescribed kinds of chemical durability index values are measured. Then, the “haze values” and the “weight variation values” are used as the prescribed kinds of chemical durability index values in this embodiment. This is because by using the “haze values” and the “weight variation values”, and particularly using the “haze values”, the degradation of a surface state of the glass sample with elapse of time (for example the degradation in the state of the glass material due to fogging) can be precisely and objectively grasped.

“Haze value” is a value indicating a degree of a so-called fogging, showing that the smaller the value is, the higher the transparency is. More specifically, the haze value is defined by the following equation: Haze value (%)=T_{d}/Tₜ×100 (T_{d}: diffusion transmittance, Tₜ: total light transmittance). Such a haze value can be measured using a haze meter defined in “Method (surface method) for measuring chemical durability of optical glass 07-1975 by Japan Optical Glass Industry Association Standard JOGIS”, and allowing the light for measurement to be transmitted vertically to two opposed main surfaces of the glass sample after being immersed in the process liquid for a prescribed time. Note that in the specification of the present application, the haze value has a similar meaning as “haze” in the “Method (surface method) for measuring chemical durability of optical glass 07-1975 by Japan Optical Glass Industry Association Standard JOGIS”.

“Weight variation value” is the value indicating a weight variation (reduction amount) of the glass sample before/after immersion into the process liquid. Such a weight variation value (g) can be measured by measuring a weight of the glass sample before/after immersion into the process liquid for a prescribed time, and calculating a differential value obtained by each measurement.

After measuring the haze value and the weight variation value of the glass sample immersed in the process liquid which is adjusted to a certain pH for a prescribed time, the haze value and the weight variation value of the sample of a new glass sample of the same type of glass as the aforementioned glass sample, is measured using the process liquid with pH changed, under the same condition of the process liquid excluding pH. Similar measurement technique is used as the measurement technique used before changing the pH. Namely, the haze value and the weight variation value are measured again only by changing the pH of the process liquid.

Thus, the haze value and the weight variation value corresponding to each of at least two or more pH can be obtained. Therefore, the correlation between the variation of the pH of the process liquid and the variation of the haze values in the samples of the glass material, and the correlation between the variation of the pH of the process liquid and the variation of the weight variation values in the samples of the glass material, can be grasped in each type of the glass samples. Namely, information regarding the correlation between the variation of pH and the variation of the chemical durability index values (more specifically the variation of the haze values and the weight variation values), can be obtained in each type of the glass materials, by testing the glass materials using the aforementioned methods.

Note that the haze value and the weight variation value may be measured, regarding at least two pH. This is because the correlation between the variation of pH and the variation of the chemical durability index values can be grasped by performing the measurement regarding at least two pH. However, preferably three or more pH from acidity to alkalinity should be measured, like pH=3, 2, 6.3, 9, 0.4, 11.8. This is because precision of specifying the correlation can be improved by improving a resolving power, when three or more pH are measured.

### 3. Providing of Information

When the information is acquired regarding the correlation between the variation of pH and the variation of the chemical durability index values, in this embodiment, the acquired information is provided to the user of the glass material (fabricator, etc., of the glass material). Providing of the information is performed as described below.

### (Tabulation of Information)

When providing of the information is performed, first, the information to be provide, namely the correlation between the variation of pH and the variation of the chemical durability index values, is tabulated in the visible form. Then, the information after tabulated (called “tabulated information”) is provided individually for each type of the glass materials.

Wherein, “the information is tabulated” means that the information to be provided, namely the correlation between the variation of pH and the variation of the chemical durability index values, is indicated by a diagram (graph) or a table, or both of them.

Further, “information is provided individually for each type of the glass materials” means that the information is provided to each type of the glass materials one by one. Accordingly, simultaneous parallel providing is not necessarily required for each type of the glass materials. However, time points of providing the information may be set in parallel, like a case that the information is provided in a list form.

The following case can be given as a specific example of the tabulation in the visible form.

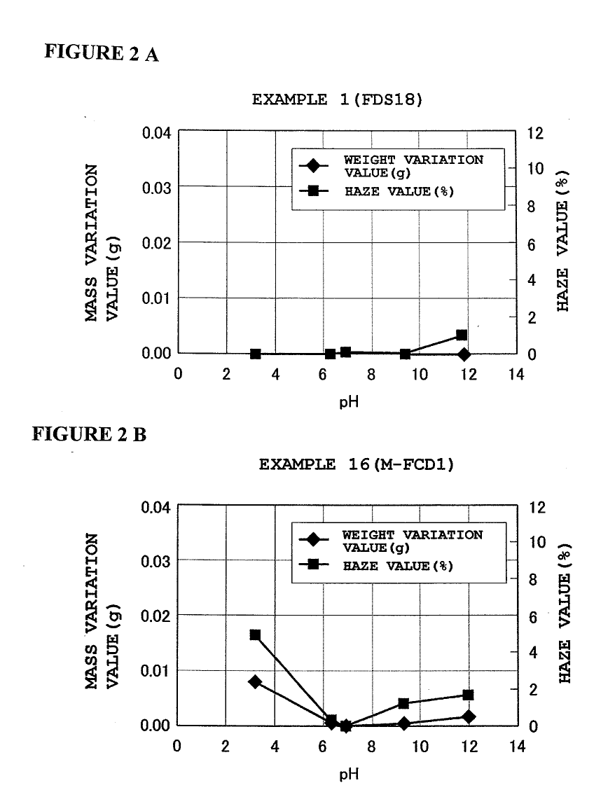

FIG. 2A shows an example of tabulating the acquired information regarding the correlation between the variation of pH and the variation of the chemical durability index values in the visible form, for the glass material called “FDS18 (by HOYA Corporation), as example 1. More specifically, the figure shows an example of a two-dimensional tabulation in a graph, with pH taken on the horizontal axis, haze values (%) taken on one of the vertical axes (right side in the figure), and weight variation values (g) taken on the other vertical axis (left side in the figure). Then, in a coordinate space on the two-dimensional graph, the correlation between the variation of pH and the variation of haze values, and the correlation between the variation of pH and weight variation values, are shown by a diagram respectively.

FIG. 2B shows an example in which the glass material called “M-FCD1(by HOYA Corporation)” is tabulated as example 16, similarly to the aforementioned case of FIG. 2A.

Owing to such a tabulation as described above, in each of the correlation between the variation of pH and the variation of the haze values, and the correlation between the variation of pH and the variation of the weight variation values, the user of the glass material can intuitively grasp pH dependency of the haze values and the weight variation values through a visual sense, with reference to the graph after tabulation.

In addition, by showing the correlation by the diagram on the two-dimensional graph, a space between discrete measurement points can be replenished, even if the acquired information is discrete. Namely, even if the measurement points of the acquired information are discrete, point information other than the measurement point can be estimated.

Note that it is a matter of course that the tabulation is not limited to the aforementioned specific example. Namely, tabulation by a diagram (graph) of other mode is acceptable, or tabulation by a table form is acceptable, and tabulation by suitable combination of them is acceptable, provided that the pH dependency of the haze values, etc., is visible.

### (List Form)

The aforementioned tabulation of information is performed individually for each type of the glass materials. This is because if the glass type is different, the chemical durability is also different. Namely, since acquisition of information regarding the chemical durability is different, it is a matter of course that the content of tabulating this acquired information is also different for each type of the glass materials. Accordingly, the tabulation as shown in FIG. 2A or FIG. 2B is made for each type of the glass materials.

Meanwhile, the glass material includes a plurality of glass types. Then, it is generally known that each type of the glass materials is classified by mapping at positions corresponding to each value on the graph (called “glass map” hereafter), with refractive index nd taken on the vertical axis, and Abbe number νd taken on the horizontal axis.

Regarding a plurality of glass types that exist on the glass map classified by refractive index nd and Abbe number νd as described above, it can be considered that the information tabulated individually for each glass type is shown by a list form on the glass map. When the information is shown in the list form, the pH dependency of the haze values, etc., can be grasped and the difference in the pH dependency between glass types can be easily grasped, in each glass type.

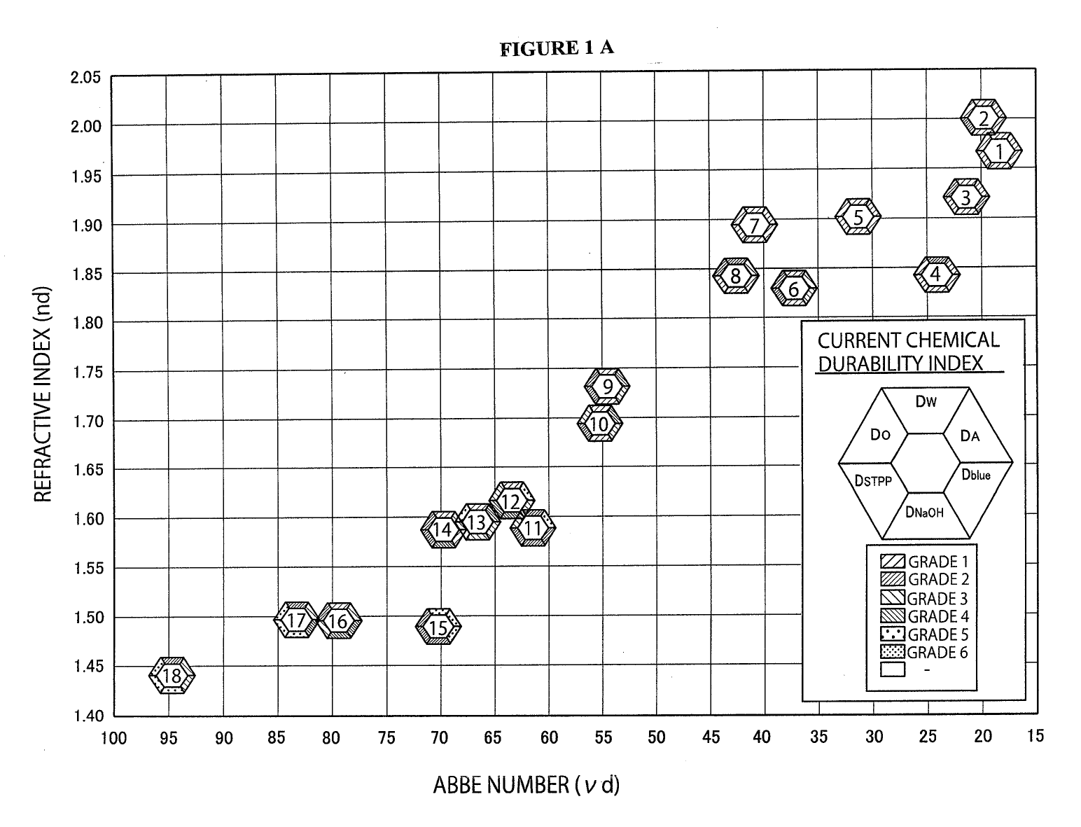

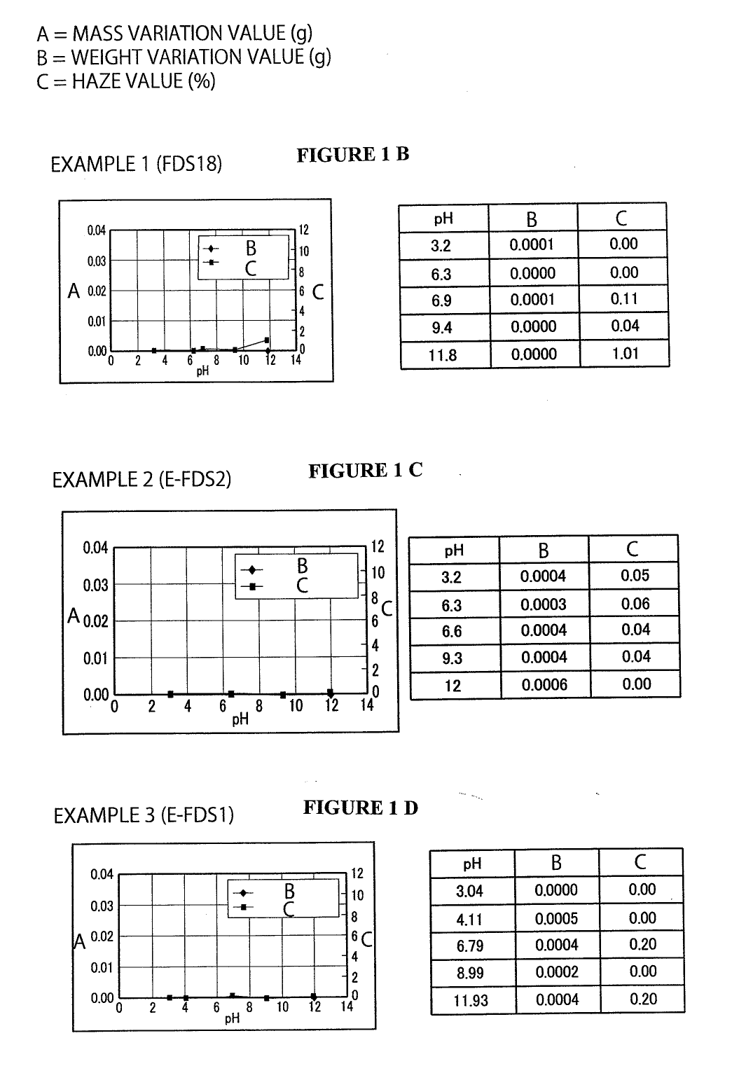

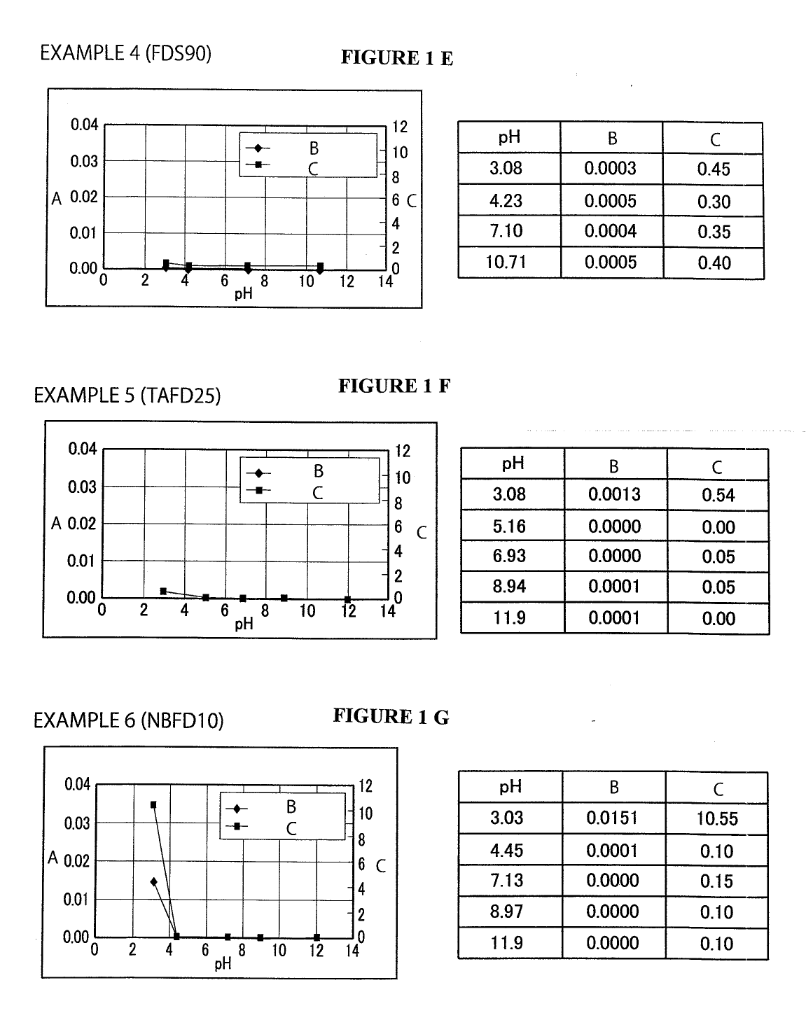

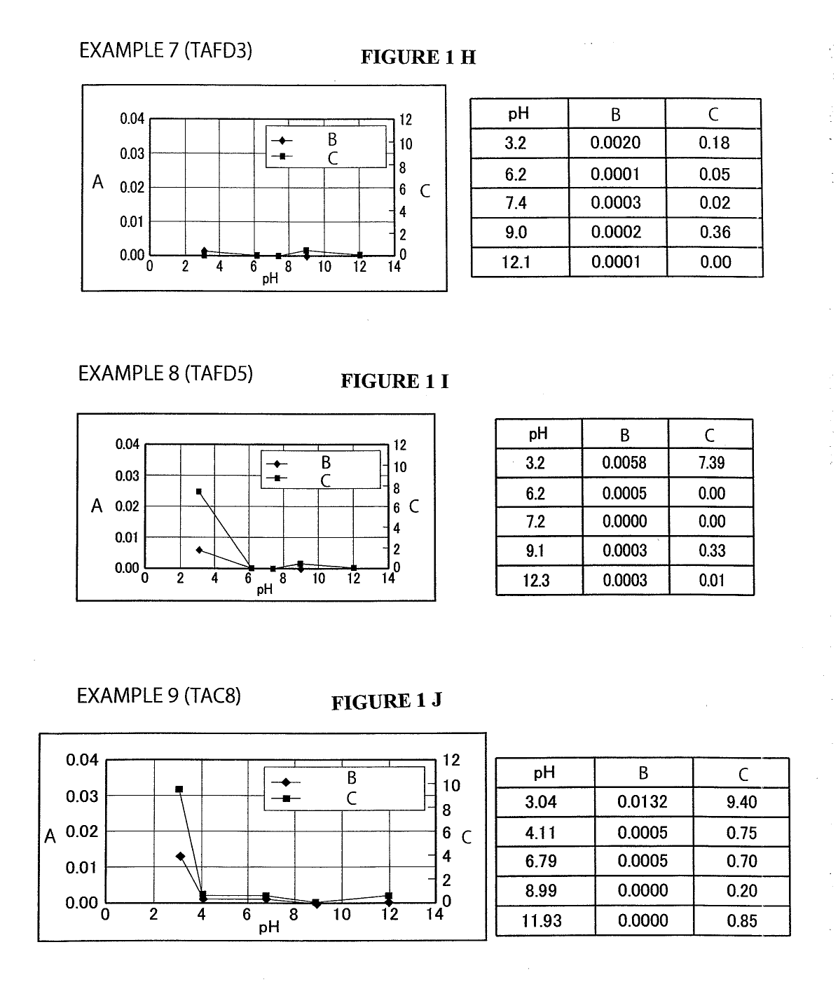

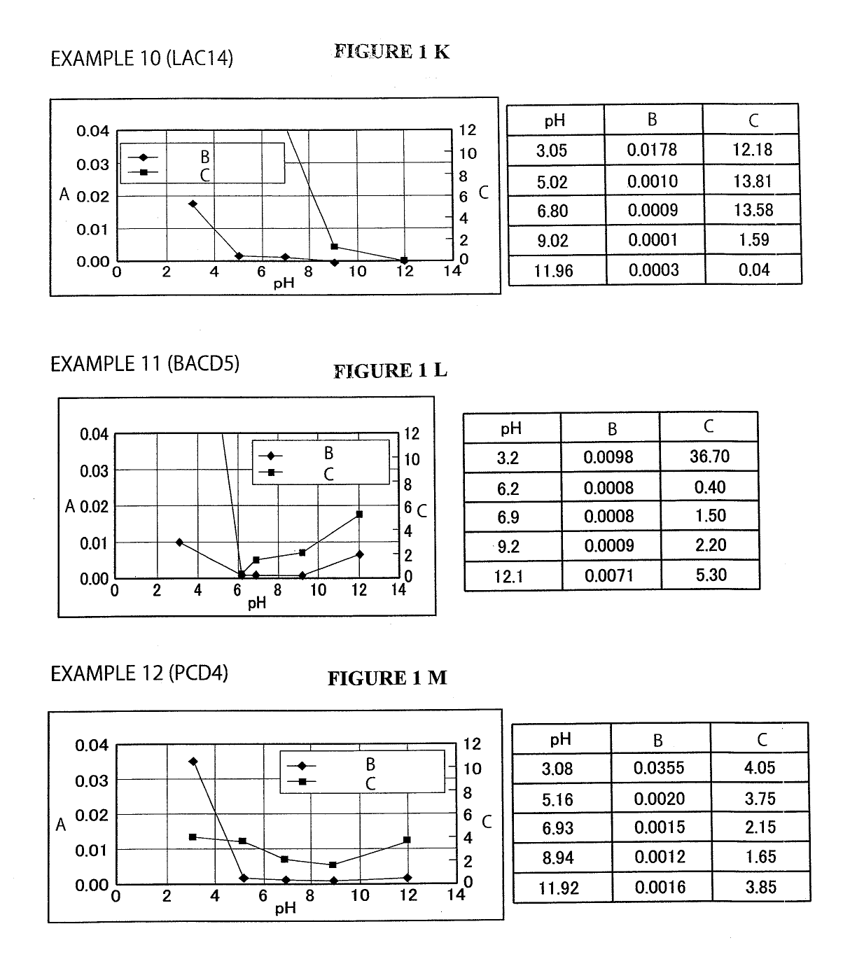

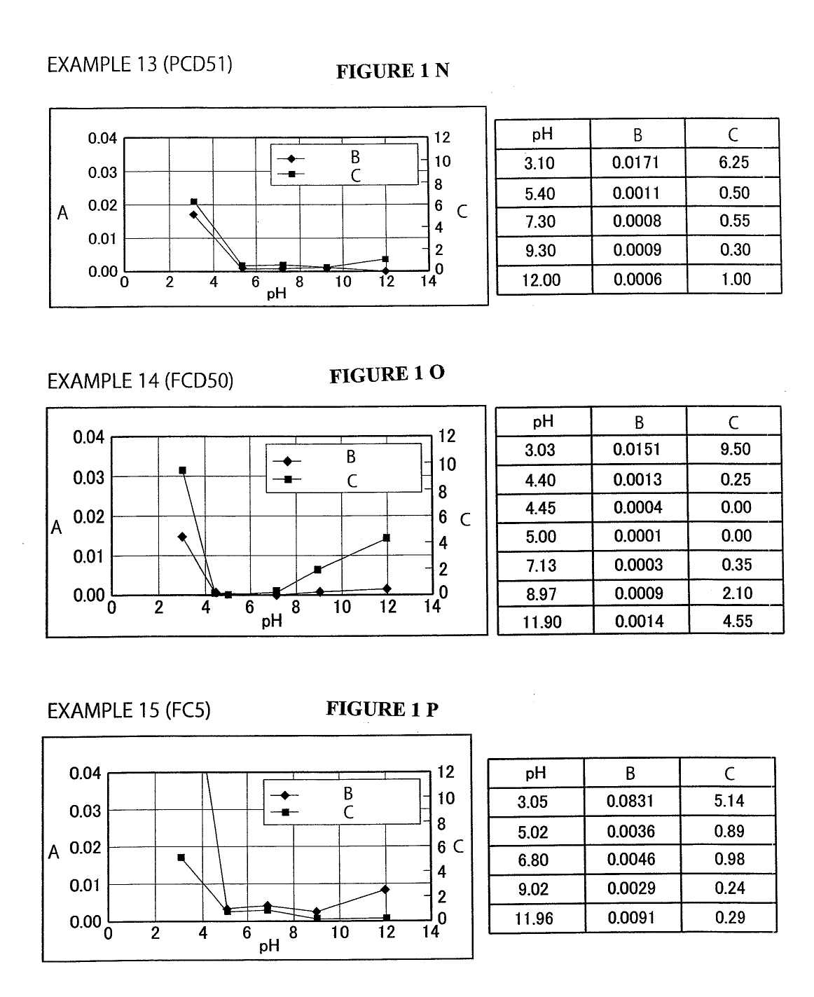

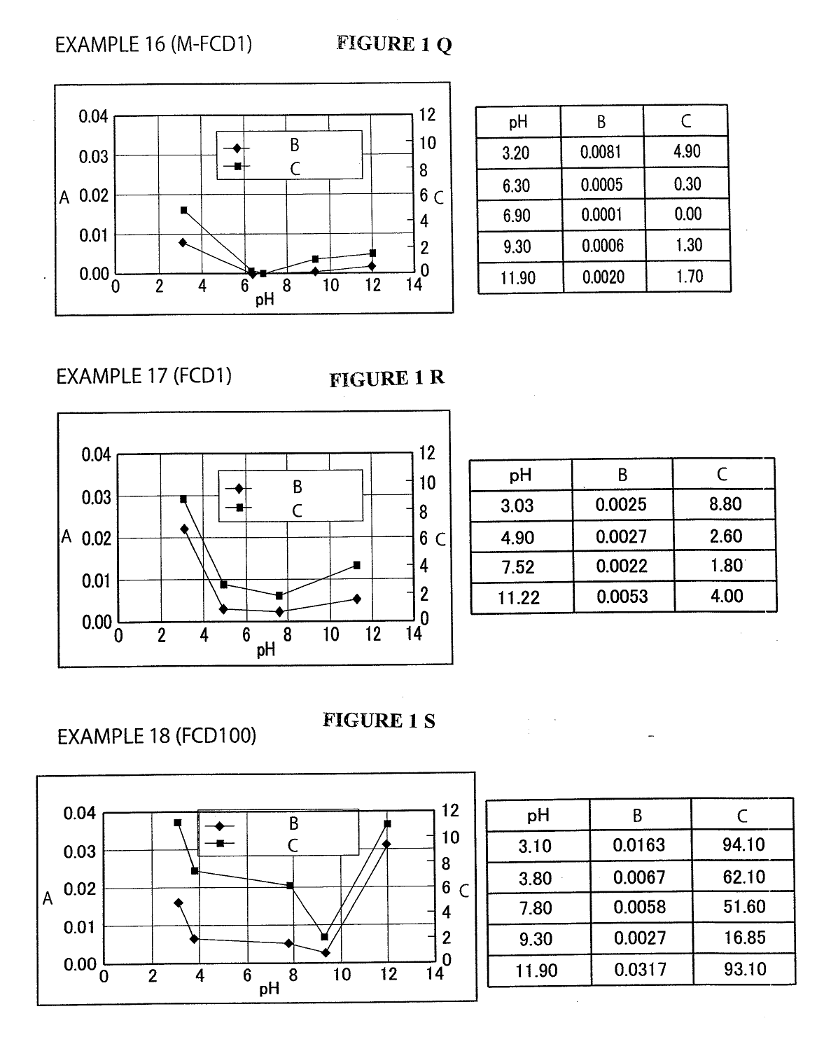

Regarding a plurality of glass types that exist on the glass map (more specifically, each glass type of examples 1 to 18 including the aforementioned examples 1, 16), the example shown in FIG. 1 shows a plurality of tabulated information corresponding to each glass type in the list form, in association with each mapping position (specifically, in association with each mapping position by arrangement in the vicinity of the mapping position or using a pattern such as an arrow). However, the example of the figure shows simply one of the specific examples of a list form display, and it is a matter of course that the list form display is not limited thereto.

### (Providing of Information)

It can be considered that the aforementioned tabulated information is provided to the user of the glass material as described below, irrespective of whether the information is shown in a single form for each glass type, or is shown in the list form for a plurality of glass types.

For example, the tabulated information of each glass type is provided to the user of the glass material by being listed on a paper medium such as a catalogue for introducing each type or the glass materials.

The tabulated information may also be provided to the user of the glass material not through the paper medium but through digital media, like in a case that each type of the glass materials is posted on its internet website, or is electronized in a form that can be outputted by a computer device and is stored in a recording medium.

Further, for example, it can also be considered that the paper medium on which the tabulated information is printed or the recording medium in which the tabulated information is electronized and stored, is attached to the glass material being a commercial product that is distributed in a business market, to thereby provide the information to the user of the glass material. In this case, the tabulated information attached to the glass material corresponds to a part of constituting elements of the glass material (commercial product). Namely, the glass material described in this embodiment has the tabulated information attached thereto in each type of the glass materials as a part of the constituting element of the commercial product.

### 4. Utilization of Information

In this embodiment, the tabulated information provided to the user of the glass material, is utilized as described below.

### (Judgment Evaluation of Proper pH)

According to the provided tabulated information, the pH dependency of the haze values and the weight variation values can be grasped. In other words, the influence of pH of the process liquid in which the glass material is immerse, on the chemical durability index values in this glass material, can be grasped. Accordingly, by referring to the tabulated information in the visible form, the chemical durability of the glass material reflecting the influence of the pH variation of the process liquid, can be evaluated.

More specifically, an example of the glass material called “FDS18” is given (see FIG. 2A) as follows. When pH is varied in a range of 3.2 to 11.8, it is found that although the haze value indicates a low value in a range of 0.00 to 0.11% in a case of pH≦9.4, the haze value is increased to 1.01% in a case of pH=11.8.

Accordingly, regarding the “FDS18”, for example when the haze value is used as the chemical durability index value and its allowable value is set to 2% or less, pH of the process liquid can be set at least in a range of 3.2 or more and 11.8 or less. Further, even if the weight variation value is used as the chemical durability index value and its allowable value is set to 0.01 or less, pH of the process liquid can be set in the same range. Meanwhile, when the allowable value of the haze value is set in the vicinity of 0% (for example, 0.20% or less), it is found that pH of the process liquid is required to be set at least in a range of 3.2 or more and 9.4 or less.

Further, as another example, an example of using the glass material called “M-FCD1” is given as follows. When this glass material is tested by the conventional technique, all grades of the chemical durability are low as shown in FIG. 1. If the acquiring of information as described in this embodiment is performed to this glass material, the correlation between the variation of pH and the variation of the haze values can be obtained as shown in FIG. 2B. From this figure, it is found that the haze value of 1% or less is achieved if pH of the process liquid is in a range of 6.3 or more and 6.9 or less. Namely, although “M-FCD1” is inferior to “FDS18” in terms of the grade of the chemical durability of the conventional technique, the optical element having high chemical durability (here, low haze value) which is not inferior to a high grade glass material can be obtained by setting pH of the process liquid to 6.3 or more and 6.9 or less, which is the process liquid used for producing the optical element as a product.

Namely, this embodiment realizes selection of pH by providing the tabulated information of this embodiment, which is a proper pH of the process liquid used for applying processing to each type of the glass materials, wherein pH is selected so that the corresponding chemical durability index value is set in a range of an allowable value, based on the correlation between the variation of pH and the variation of the chemical durability index values for each grass type specified by the aforementioned tabulated information.

In this case, it can be considered that based on an experimental rule obtained by executing a pre-test for example, the allowable value of the chemical durability index value is set to a prescribed value, such as 1% or less of the haze value, and 0.001 g or less of the weight variation value. Note that the allowable value may be uniformly set for each glass type, or may be set individually for each glass type.

### (Appropriating a Processing Condition)

Incidentally, the optical element such as a lens and a prism can be obtained by processing the glass material being a material for forming the optical element. Then, processing steps of the glass material generally include a step of processing the glass material, with the glass material immersed in the process liquid (such as polishing liquid and cleaning liquid).

When executing the step of immersing the glass material in the process liquid, the following processing can be realized. Namely, as described in this embodiment, the tabulated information is provided prior to executing the aforementioned step, and based on the provided tabulated information, proper pH of the process liquid is selected, and thereafter processing is applied to the glass material using the process liquid having the selected pH.

More specifically, an example of cleaning the glass material called “FDS18” is given as follows (see FIG. 2A). For example, cleaning is performed while maintaining the proper pH of the process liquid in a range of 3.2 or more and 9.8 or less, and pH of the cleaning liquid in a range of 3.2 or more and 9.8 or less, which is the process liquid used in the cleaning step, wherein the proper pH is selected in accordance with the allowable value of 1% or less of the haze value and 0.001 g or less of the weight variation value.

When the optical element is produced through the cleaning step by selecting the proper pH in the aforementioned range, the degradation with elapse of time, which is a problem conventionally, is not generated in this optical element, and a surface property of the glass material can be maintained in an excellent state.

The reason thereof is considered as follows. It can be considered that in the conventional technique, it is difficult to grasp the pH dependency of the chemical durability, and therefore processing is sometimes performed using the process liquid having pH outside a proper range. Accordingly, the latent flaw that is generated during polishing becomes apparent by immersing the glass material in strongly alkaline process liquid at the time of cleaning after polishing, thus generating the fogging on the surface of the glass material. Meanwhile, the processing condition for the process liquid in which the glass material is immersed, can be appropriated, namely, pH of the process liquid can be selected in a proper range, by utilizing the tabulated information, provided that the tabulated information of this embodiment is provided. Accordingly, it can be considered that the latent flaw does not become apparent during polishing, which becomes apparent conventionally, and as a result, the surface property of the glass material can be set in an excellent state.

Further, regarding the glass material called “M-FCD1” as well (see FIG. 2B), the degradation with elapse of time is not generated and the surface property of the glass material can be set in an excellent state, by producing the optical element through the cleaning step in a proper pH range. In addition, although M-FCD1 is relatively inferior to FDS18 in terms of the grade of the chemical durability evaluated by the conventional technique, the optical element having the chemical durability (here, low haze value) which is not inferior to the high grade glass material, can be obtained. Namely, even in a case of any kind of the grade evaluated by the conventional technique, the chemical durability supposed to be possessed by the glass material originally, namely the latent chemical durability which is not grasped by the conventional technique, can be exhibited. As a result, the glass material can be freely selected, even in a case of the glass material which is refrained from being used because it is evaluated to be a low grade in terms of the chemical durability evaluated by the conventional technique. Then, the optical element capable of sufficiently exhibiting the chemical durability while having a desired refractive index and Abbe number, can be produced.

As described above, the influence of the pH variation of the process liquid on the chemical durability index values can be grasped by utilizing the tabulated information provided in this embodiment. Therefore, the surface property of the optical element can be set in the excellent state by processing the glass material using the process liquid having pH selected based on the aforementioned grasp result. As a result, the generation of the gap between the evaluation given to the glass material and the actual surface state can be avoided.

Note that an optical lens is known as a typical example of the optical element obtained by processing the glass material. Regarding the optical lens, a lens surface is coated with an antireflection film in some cases. Even in a case of such an optical lens, the surface property can be set in the excellent state by appropriating the process condition based on the tabulated information of this embodiment. Therefore, it is confirmed that a problem such as a film peeling does not occur in the antireflection film coating the lens surface. Further, regarding the optical element other than the optical lens as well, the optical element having an excellent surface can be fabricated by selecting pH of the polishing liquid and the cleaning liquid, etc., based on the same procedure.

### 5. Effect of this Embodiment

According to the method for providing glass information, and the glass material with tabulated information attached thereto in a visible form by the method for providing glass information, effects as will be described below can be obtained.

In this embodiment, the correlation between the variation of pH of the process liquid in which the glass material is immersed, and the variation of the chemical durability index values, is tabulated in the visible form, to thereby provide such a correlation individually for each type of the glass materials. Accordingly, the user of the glass material can intuitively grasp the correlation through a visual sense, with reference to the provided tabulated information. In other words, the user of the glass material can grasp the influence of the variation of pH of the process liquid, on the chemical durability index values (namely pH dependency of the chemical durability), with reference to the provided tabulated information. Then, by grasping the pH dependency of the chemical durability, it is easy and appropriate to select the proper pH of the process liquid used for the processing of the glass material for each glass type, and apply processing (polishing and cleaning, etc.,) to the glass material using the process liquid having the selected proper pH, and produce the optical element. By producing the optical element through such a procedure, the surface degradation with elapse of time can be prevented from generating on the surface of the optical element. Namely, according to this embodiment, the pH dependency of the chemical durability is provided as the tabulated information in the visible form. Therefore, even after the glass material is turned into a product actually by utilizing such tabulated information, the gap between the evaluation given to the glass material and the actual surface state of the glass material can be prevented. In addition, even in a case of the glass material whose chemical durability evaluated by the conventional technique is evaluated to be a low grade, by setting pH of the process liquid used for producing the optical element in a range determined for each type of the glass materials, the chemical durability of the glass material can be sufficiently extracted so that the evaluation of the chemical durability is not inferior to the evaluation of the optical element which is based on a high grade glass material. Namely, the chemical durability supposed to be possessed by the glass material originally, namely the latent chemical durability which is not completely grasped by the conventional technique, can be exhibited. Therefore, the user of the glass material can freely select the glass material, even in a case of the glass material which is refrained from being used because it is evaluated to be a low grade in terms of the chemical durability evaluated by the conventional technique. Then, the optical element capable of sufficiently exhibiting the chemical durability while having a desired refractive index and Abbe number, can be produced.

Further, in this embodiment, at least the haze value is used as the chemical durability index value in the provided tabulated information. This is because a slight fogging on the surface of the glass material is reflected on a numerical value by using the haze value. Namely, generation of a slight surface degradation can be prevented. Accordingly, in this embodiment, the generation of the gap between an evaluation result and actual surface state can be surely prevented by using the haze value as the chemical durability index value. Note that at least the haze value is preferably used as the chemical durability index value, for the aforementioned reason.

Further, in this embodiment, the weight variation value of the glass material is used in addition to the haze value as the chemical durability index value, in the provided tabulated information. This is because a different behavior is shown between the haze value and the weight variation value in some cases in the variation of pH of the process liquid, even in a case of the same type of glass material. Namely, by using the haze value and the weight variation value as the chemical durability index value, even in a case that both values show different behaviors, proper pH can be surely selected so as not to allow the surface degradation to be generated, while responding to the different behaviors respectively.

Further, in this embodiment, in the provided tabulated information, tabulation is made in the graph in which pH is taken on the horizontal axis, the haze value is taken on one of the vertical axes, and the weight variation value is taken on the other vertical axis. Accordingly, both behaviors of the haze value and the weight variation value can be grasped in one graph, thus realizing extremely high usability for the user of the glass material.

Further, in this embodiment, the tabulated information for each glass type is provided in the list form on the glass map. Accordingly, the behavior of the haze value, etc., with respect to the pH variation of the process liquid is different for each glass type, which can be easily and surely grasped. Thus, pH suitable for each glass type can also be easily and surely selected.

### 6. Others

This embodiment describes a suitable aspect of the present invention. However, the present invention is not limited to the content of this embodiment, and can be suitably modified in a range not departing from the gist of the present invention.

### (Modified Example of the Chemical Durability Index Value)

This embodiment describes a case that there are two chemical durability index values (namely “haze value” and “weight variation value”). Meanwhile, the concept of the present invention can be used even in a case that there is one chemical durability index value. More specifically, only the correlation between the variation of pH of the process liquid and the variation of the haze values is grasped, and such a relation may be provided as the tabulated information.

Further, various kinds of index values in addition to the “haze value” and the “weight variation value” can be used as the chemical durability index value, provided that it is an index showing the chemical durability. As an example thereof, “surface degradation state” can be given, which is obtained by surface observation.

### (A Modified Example of the Optical Element)

This embodiment describes a case that the optical element is the optical glass lens. As a specific example of this optical element, each kind of lens such as a spherical lens, an aspherical lens, a micro lens, diffraction grating, a lens with diffraction grating, a lens array, and a prism, etc., can be given. Further, from a surface shape, a concave meniscus lens, a biconcave lens, a plano-concave lens, a convex meniscus lens, a biconvex lens, and a plano-convex lens, etc., can be given.

Note that these lenses can be optical elements by providing thereon an optical thin film such as an antireflection film, a total reflection film, a partial reflection film, and a film having spectral characteristics as needed.

Further, the aforementioned optical element is suitable as a component of a compact image pick-up optical system with high performance, and is suitable for the image pick-up optical system such as a digital still camera, a digital video camera, a camera mounted on a cell phone, and a camera mounted on a vehicle.

### (Application to Commercial Business)

It can be considered that the method for providing glass information described in this embodiment, is executed at the time of providing the glass material being a commercial product by a fabricator or a seller of the glass material. As a result, there is an advantage that quality of the optical element produced from the glass material can be maintained to be high through utilization of the information described in this embodiment at the side of the user of the glass material who receives providing of the glass material, and production efficiency can be improved by improving a yield rate of the product of the optical element. Also, at the side of fabricators and sellers, there is an advantage that differentiation from products of others is achieved by appealing superiority to clients, which is the superiority not possessed by others such that the pH dependency of the chemical durability can be grasped by providing the information in a case that the glass material is treated by themselves.

1. A method for providing glass information for providing information regarding chemical durability of a glass material, comprising:
tabulating a correlation between a variation of hydrogen ion concentration indexes of a process liquid in which the glass material is immersed, and a variation of chemical durability index values of a prescribed type of the glass materials immersed in the process liquid, in a visible form; and
providing the correlation individually for each type of the glass materials.

2. The method of claim 1, wherein haze values of the glass materials after being immersed in the process liquid for a prescribed time, are used as the chemical durability index values.

3. The method of claim 2, wherein weight variation values of the glass materials before/after being immersed in the process liquid for a prescribed time, are used as the chemical durability index values.

4. The method of claim 3, wherein tabulation is made in a graph in which the hydrogen ion concentration indexes are taken on the horizontal axis, and the haze values are taken on one of the vertical axes, and the weight variation values are taken on the other vertical axis.

5. The method for providing glass information according to claim 1, wherein information tabulated individually for each glass type is provided in a list on a glass map, regarding a plurality of glass types that exist on the glass map classified by refractive index nd and Abbe number νd.

6. A glass material, which is the glass material being a material for forming an optical glass, wherein a correlation between a variation of hydrogen ion concentration indexes of a process liquid in which the glass material is immersed, and a variation of chemical durability index values of a prescribed type of the glass materials immersed in the process liquid, is attached individually for each type of the glass materials in a tabulated state and in a visible form, as information regarding the chemical durability of the glass materials.

7. The method for providing glass information according to claim 2, wherein information tabulated individually for each glass type is provided in a list on a glass map, regarding a plurality of glass types that exist on the glass map classified by refractive index nd and Abbe number νd.

8. The method for providing glass information according to claim 3, wherein information tabulated individually for each glass type is provided in a list on a glass map, regarding a plurality of glass types that exist on the glass map classified by refractive index nd and Abbe number νd.

9. The method for providing glass information according to claim 4, wherein information tabulated individually for each glass type is provided in a list on a glass map, regarding a plurality of glass types that exist on the glass map classified by refractive index nd and Abbe number νd.
